(19) United States
(12) Patent Application Publication
(10) Pub. No.: US 2009/0290645 A1
(43) Pub. Date: Nov. 26, 2009

(54) System and Method for Using Coded Data From a Video Source to Compress a Media Signal

(75) Inventor: Danny L. Mabey, Farmington, UT (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: BROADCAST INTERNATIONAL, INC., Salt Lake City, UT (US)

(21) Appl. No.: 12/430,505

(22) Filed: Apr. 27, 2009

Related U.S. Application Data
(60) Provisional application No. 61/055,083, filed on May 21, 2008.

(51) Int. Cl. H04N 7/12

(52) U.S. Cl. 375/240.25; 375/E07.027

(57) ABSTRACT

Systems and methods disclosed herein create encoder sensitive video using single and/or bidirectional communication links between a video source and an encoding process to pass metadata (e.g., instructions and cues related to the video stream) to an encoder. A video system includes a video source to generate an uncompressed video stream and metadata corresponding to one or more characteristics of the uncompressed video stream. The video source may include, for example, a video camera or video editing equipment. The metadata may be based on a position, state, movement or other condition of the video source. The system also includes a codec communicatively coupled to the video source. The codec receives the uncompressed video stream and compresses it based on the one or more characteristics indicated in the metadata.

### RELATED APPLICATIONS

This application claims the benefit under 35 U.S.C. §119(e) of U.S. Provisional Application No. 61/055,083, filed May 21, 2008, which is hereby incorporated by reference herein in its entirety.

### TECHNICAL FIELD

The present disclosure relates generally to the field of data management and communication. More specifically, the present disclosure relates to the acquisition, compression, and delivery of video and audio signals.

### BRIEF DESCRIPTION OF THE DRAWINGS

FIG. 1 is a block diagram of a video source configured to provide compression sensitive video to a codec according to one embodiment.

FIG. 2 is a block diagram of a conventional communication system using data compression.

FIG. 3 is a block diagram of a communication system using multiple codecs for compressing portions of a media signal according to one embodiment.

FIG. 4 is a block diagram of a system including a video source and an encoder according to one embodiment.

### DETAILED DESCRIPTION

Systems and methods disclosed herein create encoder sensitive video using single and/or bidirectional communication links between a video source and an encoding process to pass metadata (e.g., instructions and cues related to the video stream) to an encoder. The video source may include, for example, a video camera or video editing system. The metadata generated by the video source provides the encoder with valuable information on what to expect in the video stream. A new class of codecs or modified algorithms, according to certain embodiments, takes advantage of this new source of information. For example, a video camera may indicate when recording starts and stops, and/or when it is panned, tilted, or zoomed. As another example, a video editing system used to edit raw video may indicate the type of transition (e.g., swipe, dissolve, etc.) used between scenes. In addition, or in other embodiments, the video camera may allow a user to specify selective capturing. For example, the video camera may use user input to generate a requested digital pattern or set of digital data for compression.

Thus, the metadata reduces the amount of processing performed by the encoder to estimate the characteristics of the video stream. In one embodiment, the encoder switches between codecs to improve or optimize encoding of a current portion of the video stream (e.g., for a particular scene or motion within a scene) based on the metadata provided by the video source. In addition, or in other embodiments, codec settings are selected based on the metadata provided by the video source.

In certain embodiments, the encoder may also provide information back to the video source to select settings that improve or optimize compression. For example, the encoder may determine that changing a gain setting used by the video source will improve video compression. Thus, the encoder may send a command to the video source to select the desired gain setting.

Reference is now made to the figures in which like reference numerals refer to like elements. For clarity, the first digit of a reference numeral indicates the figure number in which the corresponding element is first used.

In the following description, numerous specific details of programming, software modules, user selections, network transactions, database queries, database structures, etc., are provided for a thorough understanding of the embodiments of the invention. However, those skilled in the art will recognize that the embodiments can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

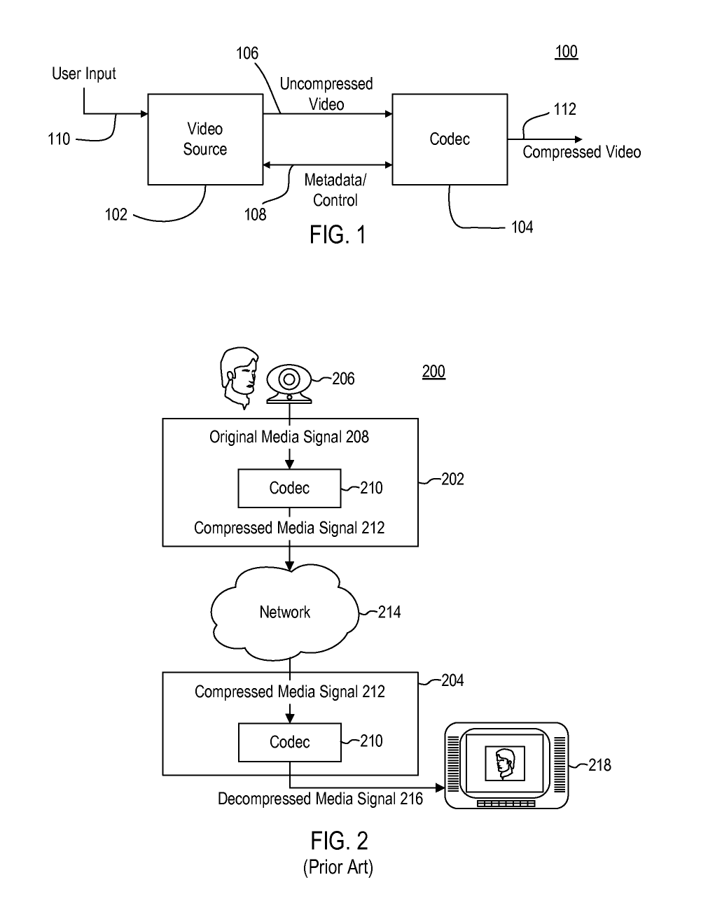

FIG. 1 is a block diagram of a video source 102 configured to provide compression sensitive video to a codec 104 according to one embodiment. The video source 102 may include, for example, a video camera and/or video editing equipment. The video source 102 provides uncompressed video 106 to the codec 104. As used herein, “uncompressed video” is a broad term that includes its ordinary and customary meaning and is sufficiently broad so as to include raw video data as well as video data that has been formatted and/or partially compressed before being provided to the codec 104 for final compression. For example, a video camera that generates video data may provide initial formatting, resolution adjustment, and/or a comparatively small amount of compression before the codec 104 converts the video data to an MPEG compression format. The video source 102 also provides metadata 108 to the codec 104 that includes instructions and cues (e.g., video properties) used for compressing the uncompressed video 106.

As discussed in detail below, the video source 102 may use user input 110 and/or internal sensors (not shown) to determine video properties such as motion (e.g., pan, tilt, and zoom), face recognition, new scenes, scene transitions (e.g., dissolve, fade, and swipe), and other properties. In addition, or in other embodiments, the video source 102 may use user input to generate a requested digital pattern or set of digital data for compression. The video source 102 communicates the video properties in the metadata 108. The codec 104 uses the metadata 108 to improve or optimize the compression of the uncompressed video 106. The codec 104 then outputs the compressed video 112 for communication (e.g., through a network) or storage (e.g., on digital versatile disc (DVD), magnetic hard drive, flash memory device, or other memory device). The codec 104 may reside, for example, in memory devices, graphics processing units (GPUs), cards, elements of cards, multi-core processors, or field-programmable gate arrays (FPGAs).

In one embodiment, the video source 106 provides the uncompressed video 106 and the metadata 108 through separate communication channels. For example, the video source 102 may provide the uncompressed video 106 through a primary communication channel and the metadata 108 through a secondary or “back” channel. In another embodiment, the video source 102 may combine the uncompressed video 106 and the metadata 108 in a single communication channel. For example, the metadata 108 may be included in a header of a packet that includes the uncompressed video 106 as the packet payload.

In one embodiment, the codec 104 provides a control signal back to the video source 10. The video source 102 uses the control signal to select settings that improve or optimize compression. As shown in FIG. 1, the control data may be communicated over the same channel as the metadata 108. Thus, it may be communicated through a back channel or as header information. The codec 104 may, in another embodiment, provide the control signal directly video source 102 through its own dedicated communication channel.

The codec 104 may control the video source 102 to improve overall system performance. For example, in one embodiment, the codec 104 provides an adaptive delivery solution in which it selectively controls the resolution and/or video rate produced by the video source 102. In such an embodiment, the codec 104 may send dummy packets to a receiving device (not shown), such as a set-top-box, to determine the receiving device's capabilities. The receiving device may respond, for example, that it is only capable of outputting standard definition (e.g., 640×480) signal. Thus, the codec 104 may command the video source 102 to switch its output from high definition (e.g., 1920×1080) to standard definition. Accordingly, the codec 104 may reduce the amount of time it spends compressing data that is not useful to the receiving device.

Similarly, in certain embodiments, the codec 104 may control the video source 102 so as to provide scalable video coding (SVC) and/or a variable bit rate (VBR) based on system requirements or the abilities of the receiving device. In other words, the codec 104 may control the quality of the video stream provided by the video source 102 so as to stay within system limits. In a security encoding process, for example, properties of a communication link may be provided to the codec 104, which in turn controls the video source 102 to adjust the bit rate or type of information provided for encoding.

In addition, or in other embodiments, the codec 104 may control filtering applied by the video source 102 based on requirements for compression and delivery of the video signals. The video source 102 provides preprocessing and data filtering that may be adjusted for different situations. For example, a Bayer filter or other color filter array may be adjusted to provide a desired color gamut based on desired quality and available bit rate. For example, to reduce the bit rate, the codec 104 may command the video source 102 to filter out certain colors that are less likely to be detected by the average human eye.

Although FIG. 1 illustrates the codec 104 as being external to the video source, in certain embodiments the codec 104 is included within the video source 102. Initially, digital cameras were used to imitate and emulate film devices. Digital camera capabilities, however, have now moved far beyond film because digital cameras are no longer limited to producing static hardcopy prints and transparencies, or streaming video. Rather, digital cameras are also used as active visual communication devices, which replace not only film devices but also the dependency on external communication and computer support devices. For example, the AMBA 3 AXI protocol-based digital camera subsystem uses automated subsystem assembly tools as a PDA design with a 4-master/8-slave interconnect fabric. The AMBA 3 AXI synthesizes to 400 MHz in a typical 90 nm process. The peak bandwidth is 400 MHz*32 bits=12.8 Gbps on a single master/slave link. It includes two read-and-write channels×four masters×12.8 Gbps, resulting in a system bandwidth of 102.4 Gbps. In certain embodiments, the codec 104 is included in such an AMBA 3 AXI protocol-based digital camera subsystem.

As the computational base and pass through capability increases, the codec 104 may reside in the digital environment either internal or external to the video source 102. Thus, the codec 104 may manage capture as well as delivery characteristics and methods. This design allows capture, encoding and playback in a comprehensive, highly integrated solution. This design also provides internalization and communication of currently external computations for motion vectors to motion features, spatial redundancy, and interframe represented by macro-block displacement vectors relative to (for example) the previous frame range of motion directions.

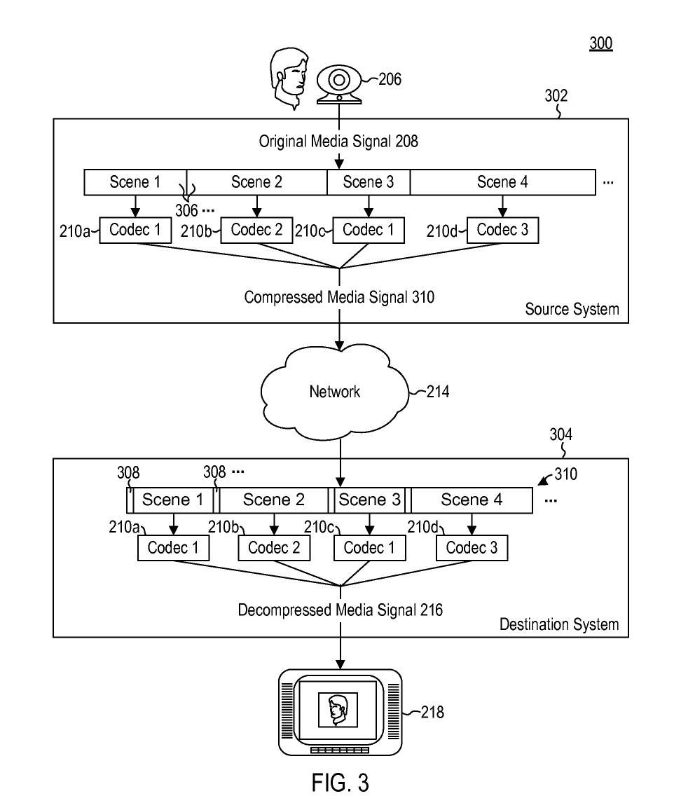

In certain embodiments, the codec 104 is a single codec that is capable of switching between different types of compression and/or internal settings to maintain a target data rate, quality, and other processing parameters discussed herein based on the data received from the video source 102. In addition, or in other embodiments, as discussed below with respect to FIG. 3, the codec 104 may include multiple codecs that are dynamically selected based on the data received from the video source 102.

FIG. 2 is a block diagram of a conventional system 200 for communicating media signals from a source system 202 to a destination system 204. The source and destination systems 202, 204 may be variously embodied, for example, as personal computers (PCs), cable or satellite set-top boxes (STBs), or video-enabled portable devices, such as personal digital assistants (PDAs) or cellular telephones.

A video camera 206 or other device captures an original (uncompressed) media signal 208 and provides the original media signal 208 to a codec 210. As discussed above, a video editing system may also provide the original media signal 208 to the codec 210. The codec (compressor/decompressor) 210 processes the original media signal 208 to create a compressed media signal 212, which may be delivered to the destination system 204 via a network 214, such as a local area network (LAN) or the Internet. Alternatively, the compressed media signal 212 may be written to a storage medium, such as a CD, DVD, flash memory device, or the like.

At the destination system 204, the same codec 210 processes the compressed media signal 212 received through the network 214 to generate a decompressed media signal 216. The destination system 204 then presents the decompressed media signal 216 on a display device 218, such as a television or computer monitor.

Conventionally, the source system 202 uses a single codec 210 to process the entire media signal 208 during a communication session or for a particular storage medium. However, a media signal is not a static quantity. Video signals may change substantially from scene to scene. A single codec, which may function well under certain conditions, may not fare so well under different conditions. Changes in available bandwidth, line conditions, or characteristics of the media signal, itself, may drastically change the compression quality to the point that a different codec, or different codec settings, may do much better. In certain cases, a content developer may be able to manually specify a change of codec 210 within a media signal 208 where, for instance, the content developer knows that one codec 210 may be superior to another codec 210. However, this requires significant human effort and cannot be performed in real time.

Codec designers generally attempt to fashion codecs that produce high quality compressed output across a wide range of operating parameters. Although some codecs, such as MPEG-2, have gained widespread acceptance because of their general usefulness, no codec is ideally suited to all purposes. Each codec has individual strengths and weaknesses.

Generally, audio/video codecs use encoding and decoding algorithms that are designed to compress and uncompress audio/video signals. In the encoding/decoding process, special instruction sets are passed from the encoder to the decoder to direct the reconstruction of the video at the player side. While a strong communication process exists between the encoder and decoder, there is limited, if any, communication between the encoder and the video source, e.g., the video camera or editing bay. Thus, the encoding codecs rely on complex algorithms to predict items like motion estimation, scene changes, and illuminants effects. Some codecs, for example the H.264 series (MPEG-4), are challenged by pan-tilt-zoom (PTZ) motion effects, which are typically directed by a user of the video source.

Thus, in one embodiment, PTZ motion effects and other video stream characteristics are communicated from a video source to the encoder. Other video stream characteristics provided to the encoder may include, for example, focus, gain field of movement, camera movement, and vibration reduction. Providing such information to the encoder simplifies the encoding task and results in higher picture quality, lower file size, and more efficient codec performance.

FIG. 3 is a block diagram of a system 300 for communicating media signals from a source system 302 to a destination system 304 according to one embodiment. As before, the source system 302 receives an original (uncompressed) media signal 208 captured by a video camera 206 or provided from another device such as a video editing system.

However, unlike the system 200 of FIG. 2, the depicted system 300 is not limited to using a single codec 210 during a communication session or for a particular storage medium. Rather, as described in greater detail below, each scene 306 or segment of the original media signal 208 may be compressed using one of a plurality of codecs 210. A scene 306 may include one or more frames of the original media signal 208. In the case of video signals, a frame refers to a single image in a sequence of images. More generally, however, a frame refers to a packet of information used for communication.

As used herein, a scene 306 may correspond to a fixed segment of the media signal 208, e.g., two seconds of audio/video or a fixed number of frames. In other embodiments, however, a scene 306 may be defined by characteristics of the original media signal 208, i.e., a scene 306 may include two or more frames sharing similar characteristics. When one or more characteristics of the original media signal 208 changes beyond a preset threshold, the video source (e.g., the camera 206) may indicate to the system 302 that a new scene 306 has begun. Thus, while the video camera 206 focuses on a static object, a scene 306 may last until the camera 206, the object, or both are moved.

As illustrated, two adjacent scenes 306 within the same media signal 208 may be compressed using different codecs 210. The codecs 210 may be of the same general type, e.g., discrete cosine transform (DCT), or of different types. For example, one codec 210a may be a DCT codec, while another codec 210b is a fractal codec, and yet another codec 210c is a wavelet codec.

Unlike conventional systems 200, the system 300 of FIG. 3 automatically selects, from the available codecs 210, a particular codec 210 best suited to compressing each scene 306 based on metadata provided from the video source (e.g., the camera 206). In one embodiment, the system 300 “remembers” which codecs 210 are used for scenes 306 having particular characteristics. If a subsequent scene 306 is determined to have the same characteristics, based on the metadata, the same codec 210 is used. However, if a scene 306 is found to have substantially different characteristics from those previously observed, based on the metadata, the system 300 tests various codecs 210 according to one embodiment on the scene 306 and selects the codec 210 producing the highest compression quality (i.e., how similar the compressed media signal 310 is to the original signal 208 after decompression) for a particular target data rate.

The system 300 may also select the codec settings to use to compress each scene 306 based on the metadata provided by the video source. As used herein, codec settings refer to standard parameters such as the motion estimation method, the GOP size (keyframe interval), types of transforms (e.g., DCT vs. wavelet), noise reduction for luminance or chrominance, decoder deblocking level, preprocessing/postprocessing filters (such as sharpening and denoising), etc.

In addition, the source system 302 reports to the destination system 304 which codec 210 and settings were used to compress each scene 306. As illustrated, this may be accomplished by associating codec identifiers 308 with each scene 306 in the resulting compressed media signal 310. The codec identifiers 308 may precede each scene 306, as shown, or may be sent as a block at some point during the transmission. The precise format of the codec identifiers 308 is not crucial and may be implemented using standard data structures known to those of skill in the art.

The destination system 304 uses the codec identifiers 308 to select the appropriate codecs 210 for decompressing the respective scenes 306. The resulting decompressed media signal 216 may then be presented on the display device 218, as previously described.

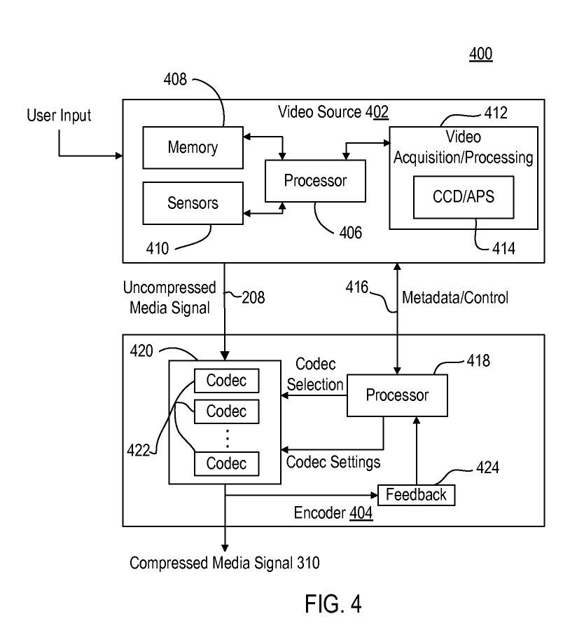

FIG. 4 is a block diagram of a system 400 including a video source 402 and an encoder 404 according to one embodiment. The video source 402 includes a processor 402, a memory 408, one or more sensors 410, and a video acquisition/processing subsystem 412. As discussed above, the video source 402 may include, for example, a video camera or video editing system. For illustrative purposes, the video source 402 shown in FIG. 4 is a video camera that includes a charge-coupled device (CCD) for acquiring images. In one embodiment, the encoder 404 communicates directly with the CCD 414. In another embodiment, the video acquisition/processing subsystem 412 may include an active pixel sensor (APS) 414, also known as a written active pixel sensor, used commonly in cell phone cameras, web cameras, and other imaging devices. In addition, or in other embodiments, the video acquisition/processing module 412 may provide audio/video editing functions.

Computer executable instructions for performing the processes disclosed herein may be stored in the memory 408. The processor 406 may include a general purpose processor configured to execute the computer executable instructions stored in the memory 408. In another embodiment, the processor 406 is a special purpose processor and may include one or more application-specific integrated circuits (ASICs) configured to perform the processes described herein. In such an embodiment, the encoder 404 may store control settings in the ASIC, which as discussed herein may be used to control parameters such as gain settings, VBR settings, SVC settings, adaptive delivery solutions, filter protocols, etc. The settings may remain constant in the ASIC until replaced by the encoder 404.

The video source 402 provides metadata 416 to the encoder 404 for improving or optimizing compression, as discussed herein. In one embodiment, directional information is carried in a header of the metadata stream 416 and includes information from a user (e.g., user input) and/or the sensors 410 within video source 402. The sensors 410 may include, for example, accelerometers, gyroscopes, and light sensors.

The metadata 416 may also include information generated using image processing techniques for face recognition, scene recognition, motion detection, and other image characteristics. For example, in one embodiment, the processor 406 performs scene-recognition using iSAPS technology. As is known in the art, iSAPS is an original scene-recognition technology developed for digital cameras by Canon. This technology uses an internal database of thousands of different photos, and works with the DIGIC III Image Processor to improve focus speed and accuracy, as well as exposure and white balance. Software (e.g., from the CHDK project) allows this information to be accessed from the DIGIC III Image Processor. Thus, the information is available to pass to the encoder 404.

In certain embodiments, the metadata 416 includes information related to:
Zoom in and out
Pan right and left
Tilt up and down
Focus and fades
Dissolves
Camera movement including vibration and vibration stabilization
Luminas variants
Chroma change
Noise control
Charge-Coupled Devices (CCD)
CCD “drift-scanning”
Scene change
Audio volume
Bass/treble balance
Audio right and left balance
Beam splitters
Grid filters
Load balancing
Pixel flow rate
Color control/management
Constraints on the data transport stream
Rate control
Slice size
Symbol stream
Motion search and detection
Prediction (fast or slow)
Motion range
Remote system control
Delivery rate and control
Client device settings
Pixel array digital camera sensor and capture profiles
Depth maps
Color cross talk and blending
Micro lenses 3D fly eye communication units
On chip bus
Camera IP core registries
CMOS sensors
On board CPU
File size
Encoding time
Price
Quality

This information may be made available digitally in single frame and/or Group of Frame GOP nomenclatures.

The encoder 404 includes a processor 418 and a codec library 420 that includes a plurality of codecs 422. The processor 418 uses the metadata 416 from the video source 402 to select a codec 422 from the codec library 420 to compress the media signal 208 received from the video source 402. After compression, the encoder 404 outputs the compressed media signal 310.

The processor 418 in one embodiment uses the metadata 416 to select the optimal codec 422 from the codec library 420. As used herein, “optimal” means producing the highest compression quality for the compressed media signal 310 at a particular target data rate. In one embodiment, a user may specify a particular target data rate, i.e., 128 kilobits per second (kbps). Alternatively, the target data rate may be determined by the available bandwidth or in light of other constraints.

As noted above, the metadata 416 identifies individual scenes 306, as well as characteristics of each scene 306. The characteristics may include, for instance, motion characteristics, color characteristics, YUV signal characteristics, color grouping characteristics, color dithering characteristics, color shifting characteristics, lighting characteristics, and contrast characteristics. Those of skill in the art will recognize that a wide variety of other characteristics of a scene 306 may be identified.

Motion is composed of vectors resulting from object detection. Relevant motion characteristics may include, for example, the number of objects, the size of the objects, the speed of the objects, and the direction of motion of the objects.

With respect to color, each pixel typically has a range of values for red, green, blue, and intensity. Relevant color characteristics may include how the ranges of values change through the frame set, whether some colors occur more frequently than other colors (selection), whether some color groupings shift within the frame set, whether differences between one grouping and another vary greatly across the frame set (contrast).

The processor 418 may also select different codec settings based on the metadata 416 received from the video source 402. The selection of a particular codec 422 and/or codec settings provides more efficient use of compression/decompression algorithms, both lossless and lossy, at a higher quality and with reduced bit rate to deliver video and audio streams in a variety of different accepted formats, such as H.265, HVC, H.264, JPEG300, MPEG4, AC3, and AAC.

As shown in FIG. 4, the encoder according to one embodiment includes a feedback subsystem 424 used to determine adjustments in codec selection and codec settings to improve compression. The processor 418 may also use the feedback to provide control signals 416 to the video source 402 to select settings that improve or optimize compression. For example, as discussed above, the encoder 404 may command the video source 402 to adjust its gain setting.

The embodiments disclosed herein may use software at a “Head End” or point of creation in cameras and editing devices to create video and still images. The disclosed systems according to one embodiment communicate information of the camera's or editing device's functions, both automated and manually created from respective controls to the existing circuitry, to the encoding side to be integrated into the encoder software and used to remove guess work by providing specific guidance.

In one embodiment, a bidirectional communication layer or channel provides connection for the elements (e.g., video source, encoder, and receiving system) in the process from the creation to the delivery of video/audio content. Each component benefits from the efficiencies provided by the capability to communicate through this layer. As the individual elements become “smarter,” the total process increases its ability to maximize capabilities and performance.

Such a system allows for remote access and control. The system also allows optimization and maximization from capture to specialized load balanced delivery. When applied in segments, such as capture device to encoder, substantial advantages are realized. In cases where the entire chain is connected, special purpose as well as general purpose efficiencies are achievable.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention. The scope of the present invention should, therefore, be determined only by the following claims.

1. A video system comprising:
a video camera to generate an uncompressed video stream and metadata, the metadata corresponding to one or more characteristics of the uncompressed video stream based on at least one of the video camera's position, state, or movement; and
a codec communicatively coupled to the video camera, the codec configured to:
receive the uncompressed video stream and the metadata from the video camera; and
compress the uncompressed video stream based on the one or more characteristics of the uncompressed video stream included in the metadata.

2. The video system of claim 1, further comprising a sensor for generating at least a portion of the metadata.

3. The video system of claim 2, wherein the sensor provides motion information selected from the group comprising pan, tilt, zoom, and vibration.

4. The video system of claim 2, wherein the sensor is selected from the group comprising an accelerometer, a gyroscope, and a light sensor.

5. The video system of claim 2, wherein the video camera and the sensor are both configured to be attached to a tripod.

6. The video system of claim 2, wherein the sensor is located within the video camera.

7. The video system of claim 1, wherein the video camera is selected from the group comprising a charge-coupled device, and an active pixel sensor.

8. The video system of claim 7, wherein the video camera is configured to generate a requested pattern or set of digital data for compression based on a user selection.

9. The video system of claim 1, further comprising:
a video communication link for communicating the uncompressed video stream from the video camera to the codec; and
a metadata communication link for communicating the metadata from the video camera to the codec.

10. The video system of claim 1, wherein the metadata is included in a header of a packet, wherein the packet includes a video payload for communicating a portion of the uncompressed video stream between the video camera and the codec.

11. The video system of claim 1, wherein the one or more characteristics corresponding to the metadata are selected from the group comprising scene transition, start of a recording segment, stop of a recording segment, focus, vibration stabilization, luminas variants, chroma change, noise control, brightness, audio volume, bass/treble balance, audio right and left balance, use of beam splitters, and use of grid filters.

12. The video system of claim 1, wherein the codec is further configured to send control data to the video camera to thereby adjust the one or more characteristics of the uncompressed video stream.

13. A video compression method comprising:
generating an uncompressed video stream and metadata using a video camera, the metadata corresponding to one or more characteristics of the uncompressed video stream based on at least one of the video camera's position, state, or movement;
transmitting the uncompressed video stream and metadata to a codec; and
compressing the uncompressed video stream using the codec based on the one or more characteristics of the uncompressed video stream included in the metadata.

14. The method of claim 13, further comprising;
sensing data related to at least one of the camera's position, state, or movement; and
generating the sensed data based on the sensed data.

15. The method of claim 14, wherein sensing data comprises sensing the video camera's operation selected from the group comprising pan, tilt, zoom, and vibration.

16. The method of claim 14, further comprising attaching the video camera and a sensor to a tripod.

17. The method of claim 13, wherein transmitting the uncompressed video stream and metadata to a codec comprises:
establishing a first communication link for communicating the uncompressed video stream from the video camera to the codec; and
establishing a second communication link for communicating the metadata from the video camera to the codec.

18. The method of claim 13, wherein transmitting the uncompressed video stream and metadata to a codec comprises generating a data packet comprising a video payload for a portion of the uncompressed video stream and a header for the metadata.

19. The method of claim 13, wherein the one or more characteristics corresponding to the metadata are selected from the group comprising scene transition, start of a recording segment, stop of a recording segment, focus, vibration stabilization, luminas variants, chroma change, noise control, brightness, audio volume, bass/treble balance, audio right and left balance, use of beam splitters, use of grid filters to determine field of motion parameters, file size, encoding time, price, and quality.

20. The method of claim 13, further comprising transmitting control data from the codec to the video camera to thereby adjust the one or more characteristics of the uncompressed video stream.

21. A video system comprising:
means for generating an uncompressed video stream and metadata, the metadata corresponding to one or more characteristics of the uncompressed video stream as provided by the means for generating; and
means for compressing the uncompressed video stream based on the one or more characteristics of the uncompressed video stream included in the metadata.

22. The video system of claim 21, further comprising means for sensing data used for generating at least a portion of the metadata.

23. The video system of claim 22, wherein the means for sensing provides motion information selected from the group comprising pan, tilt, zoom, and vibration.

24. The video system of claim 22, wherein the means for generating the uncompressed video stream and the means for sensing are both configured to be attached to a tripod.

25. The video system of claim 22, wherein the means for sensing is located within the means for generating the uncompressed video stream.

26. The video system of claim 21, wherein the means for generating the uncompressed video stream and the metadata comprises a video camera.

27. The video system of claim 26, wherein the video camera is selected from the group comprising a charge-coupled device, and an active pixel sensor.

28. The video system of claim 21, wherein the means for generating the uncompressed video stream and the metadata comprises video editing equipment.

29. The video system of claim 21, further comprising:
means for communicating the uncompressed video stream from the video camera to the codec; and
means for communicating the metadata from the video camera to the codec.

30. The video system of claim 21, further comprising means for including the metadata in a header of a packet, wherein the packet includes a video payload for communicating a portion of the uncompressed video stream between the video camera and the codec.

31. The video system of claim 21, wherein the one or more characteristics corresponding to the metadata are selected from the group comprising scene transition, start of a recording segment, stop of a recording segment, focus, vibration stabilization, luminas variants, chroma change, noise control, brightness, audio volume, bass/treble balance, audio right and left balance, use of beam splitters, and use of grid filters.

32. The video system of claim 21, wherein the means for compressing is further configured to send control data to the means for generating the uncompressed video and the metadata to thereby adjust the one or more characteristics of the uncompressed video stream.
